(19) United States
(12) Patent Application Publication
(10) Pub. No.: US 2012/0059927 A1
(43) Pub. Date: Mar. 8, 2012

(54) APPARATUS AND METHOD FOR WIRELESS AUTONOMOUS INFANT MOBILITY DETECTION, MONITORING, ANALYSIS AND ALARM EVENT GENERATION

(75) Inventors: David Schieffelin, New York, NY (US); Alex J. Kalpaxis, Glendale, NY (US)

(73) Assignee: 24/8 LLC, Waterbury, CT (US)

(21) Appl. No.: 12/520,680

(22) PCT Filed: Dec. 21, 2007
(86) PCT No.: PCT/US07/26073

§ 371 Date: Dec. 18, 2009

Related U.S. Application Data
(60) Provisional application No. 60/876,107, filed on Dec. 21, 2006.

(51) Int. Cl. G06F 15/173; H04W 24/00

(52) U.S. Cl. 709/224

(57) ABSTRACT

Systems and methods for detecting, monitoring and profiling/correlating a subject's motions, such as rollovers, falls, shaking and tremors are disclosed. In particular, an infant's mobility event may cause critical event processing indicating that an infant has rolled over and may be suffocating. Such an event is classified as a Sudden Infant Death Syndrome (SIDS)-like event. The system may include a wireless pendant device and a wireless monitor server. The wireless pendant device is configured to measure acceleration motion of a subject, to generate acceleration data from the acceleration motion and to communicate the acceleration data with the wireless monitor server. The wireless monitor server is configured to analyze the acceleration data communicated by the wireless pendant device and to provide an output related to the analysis.

### BACKGROUND OF THE INVENTION

1. Field of the Invention

The invention relates generally to wireless monitoring systems, and more particularly, to an apparatus and method for wireless autonomous infant/baby mobility detection, monitoring, analysis, and alarm event generation.

2. Description of Related Art

Sudden Infant Death Syndrome (SIDS) is a medical condition whereby an infant suddenly stops breathing, leading to the eventual death of the infant. Unfortunately, many currently available baby monitors are usually only provided with a microphone/transmitter and a receiver/speaker, enabling persons to monitor baby noises such as crying, coughing, sneezing and sniffling. If the persons do not hear anything, they may assume the baby is sleeping, and therefore do not need to check in on the child. Unfortunately, in some tragic situations, the absence of baby noises can be deadly to the child.

Consequently, devices are known in the art that monitor breathing or baby motion to sound an alarm in the absence of such breathing or motion. However, such systems may be of limited use in a hospital or other environment where several infants need to be monitored, especially where large amounts of wired connections are required. Therefore, a need exists to more efficiently and effectively monitor and profile/correlate infant/baby motions such as rollovers, falls, shaking (mild/violent) and tremors. Infant mobility events that cause critical event processing, such as an infant rolling over, may be indicative of suffocation. Such an event is classified as a Sudden Infant Death Syndrome (SIDS) event.

There is a need for systems and methods that wirelessly relay these critical series of events to one or many monitor/alarm facilities for immediate parent or caretaker notification. The exemplary embodiments wirelessly relay critical events to a collector facility that is a default configuration, attached directly to a medically managed service provider or caregiver supporting a nursery or a hospital pediatric unit. Infant here is defined as a person under the age of 18 years or a person of limited mental or physical capability who requires nearly continuous supervision.

### SUMMARY OF THE INVENTION

In one embodiment, an apparatus for wirelessly detecting infant/baby rollovers and mobility events via a low-powered wireless pendant worn on the infant's diaper (or any part of the infant's clothing) is provided. The pendant may contain a microcontroller processor unit (MPU), a MEMS (Micro Electro Mechanical System) based a three-dimensional accelerometer. A wireless sensor network transceiver is incorporated to communicate three-dimensional accelerometer motion data to the monitor nodes. In one embodiment, a wireless monitor server performs signal averaging and temporal smoothing of the collected wireless pendant acceleration data. The wireless pendant device may send acceleration data using a mesh-type wireless network to the wireless monitor server. The monitor nodes may use motion analysis software to determine infant roll-over and to also determine normal motion as compared to abnormal situations such as falls, violent shaking and/or tremors.

In another embodiment, a method for wireless autonomous mobility detection, monitoring and analysis is provided. In one embodiment, the method may include measuring acceleration motion data of a person using a wireless pendant device, sending acceleration data generated by the person from the wireless pendant using a mesh-type wireless network to a wireless monitor server for data collection and further processing, analyzing the data to detect and monitor the motion of the person and outputting a signal related to the analyzing.

An additional byproduct capability is monitoring of actual distance covered by the infant with the wireless pendant attached to the infant's diaper (or any part of the infant's clothing). Movement of any distance within any or all of the pre-determined three dimensions can be tracked over any specified time period using the equation Path (x,y,z,t)=Σ∫∫Ax*dt+Σ∫∫Ay*dt+Σ∫∫Az*dt.

Besides detecting drastic events such as infant roll-over and falling, the system profiles and correlates the spatial-temporal dynamics of the infant with the wireless pendant attached to the infant's diaper (or any part of the infant's clothing).

This real-time/heuristic information allows for the measuring and detection of motion-related events correlated with, for example, specific SIDS development progression.

For clarity, the following terminology will be used: (1) for the wireless autonomous infant/baby pendant (attached to a diaper or any part of the infant's clothing) mobility detector/transmitter, the term wireless pendant will be used (2) for wireless monitor/receiver motion analysis collection server/event processor with alarm back-end, the term wireless monitor server will be used.

Exemplary embodiments provide a method and apparatus for real-time profiling and correlating infant/baby SIDS related mobility events with stored templates to determine normal and abnormal infant/baby mobility behaviors.

Exemplary embodiments provide a method and apparatus for real-time profiling and correlating infant mobility events with stored templates to determine normal infant mobility behaviors as compared to abnormal infant mobility behaviors.

Exemplary embodiments provide a method and apparatus for real-time/heuristic information gathering to allow for the measuring and detection of motion related events correlated with specific SIDS development progression.

Exemplary embodiments provide a method and apparatus for real-time/heuristic information gathering to allow for the measuring and detection of motion related events correlated with specific sleep and/or feeding schedules of an infant.

Exemplary embodiments provide a method and apparatus for detecting various states of motion such as infant/baby rollover, free-fall, impact, shaking, and complex linear/angular motion generated by the infant with the wireless pendant attached to the infant's diaper (or any part of the infant's clothing) and relaying them to a monitor (wireless monitor server).

Another exemplary embodiment provides a method and apparatus for detecting and analyzing “groups” of events (e.g., rollovers, sudden spin, falls, and the like) which are used as input to calculate the differential acceleration time derivatives ([d(Ax)/dt]²+[d(Ay)/dt]²+[d(Az)/dt]²), which is an algorithm for three dimensional rollovers, shake and tremor detection.

Yet another exemplary embodiment provides a method and apparatus for generating alarms and alerts based on pre-determined rules of mobility that have been analyzed by the wireless monitor server using data it has received wirelessly from the wireless pendant. The alarms, alerts and spatial-temporal data can also be sent via an Internet-enabled personal computer (PC) to medical service providers over a secure connection or to individuals identified as responders.

A further exemplary embodiment provides a method and apparatus for detecting and monitoring the degree of inactivity of an infant/baby using a wireless pendant and a wireless monitor server system. The wireless monitor server may compare or profile the inactivity against pre-determined rules. If there is excessive inactivity detected within a selected time period, a notification may be generated and appropriate alarms and/or alerts will be generated.

Another exemplary embodiment provides a method and apparatus for profiling non-fluid or erratic movements when the infant/baby is going from a lying to standing upright position state and the reverse. The wireless pendant and wireless monitor server system will provide heuristic analysis of any type of movement group over any selected time-periods. This feature can be used to determine the severity of an infant/baby condition, by performing a time-series analysis on all movements associated with a lying-to-standing (upright position state) and standing-to-lying events. By comparing or profiling these event groups with normal lying-to-standing and standing-to-lying baselines or profiles, the progression of such non-fluid or erratic movement conditions can be realized.

In a further exemplary embodiment a method and apparatus for detecting, monitoring, and profiling epileptic seizures, which cause unusual movements and sensations, loss of consciousness and emotional flux are provided. Seizures result from abnormal bursts of electrical activity in the brain. A diagnosis of epileptic seizures applies to recurrent unprovoked seizures. The wireless pendant and wireless monitor server will be used to capture, alarm and record drastic movement events over any time-period.

As will be realized, this invention is capable of other and different embodiments, and its details are capable of modification in various respects, all without departing from this invention. Accordingly, the drawings and descriptions are to be regarded as illustrative in nature and not as restrictive.

### BRIEF DESCRIPTION OF THE DRAWINGS

FIG. 1 is an example of a time-series plot demonstrating the differential acceleration time derivatives.

FIG. 2 is an example of a second time-series plot demonstrating the differential acceleration time derivatives.

FIG. 3 is an example of a time domain plot showing the distance traversed by the infant/baby having the wireless pendant attached to it.

FIG. 4 illustrates an example of a simplified high-level block diagram of the process flow between the wireless pendant and the wireless monitor server.

FIG. 5 illustrates an exemplary embodiment of the process of initializing the systems non-interrupt routines.

FIG. 6 is a block diagram of an exemplary interrupt handler.

FIG. 7 is an exemplary sequence diagram illustrating successful transmission of acceleration data (Ax, Ay, Az) from the wireless device to the wireless monitor server.

FIG. 8 illustrates an exemplary implementation of the wireless monitor server.

FIG. 9 illustrates an example of a block diagram of an eleventh-order filter.

FIG. 10 illustrates an example of a block diagram of an n^{th}-order filter.

### DETAILED DESCRIPTION OF THE INVENTION

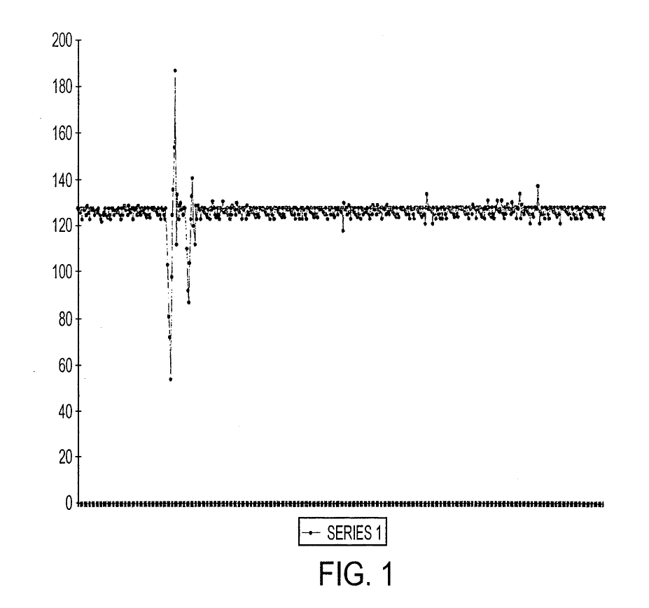

In one embodiment, using acceleration data measured in three dimensions from the wireless pendant, the time series plot of FIG. 1 can be generated using ([d(Ax)/dt]²+[d(Ay)/dt]²+[d(Az)/dt]²) algorithm for three dimensional fall detection which is a result of the infant/baby with the wireless pendant attached to its diaper (or any part of the infant's clothing) which is sending three dimensional acceleration data (Ax, Ay, Az) five times a second to wireless monitor server.

FIG. 1 is an exemplary plot of the wireless pendant's reported time-series acceleration data as processed by the wireless monitor server. These time-series plots are preferably archived for further analysis such as profiling, event capture, group correlation of events, and data mining as required by the computer application in the wireless pendant. The FIG. 1 plot indicates a fall event (the large signal spike), for example, with the vertical axis depicting acceleration in acceleration of gravity units (g=9.8 meters/sec²) (128 units on y-axis=0 g, 255=+1.5 g, 0=−1.5 g for example).

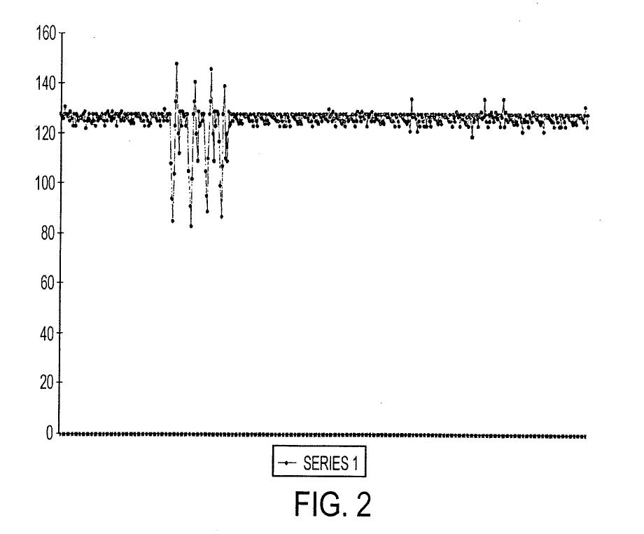

In one embodiment, FIG. 2 is a plot of the wireless pendant's reported time-series acceleration data as processed by the wireless monitor server. These time-series plots are preferably archived for further analysis such as profiling, event capture, group correlation of events, and data mining as required by the computer application. The FIG. 2 plot indicates a shaking/tremor event (the large signal spikes), for example, with the vertical axis depicting acceleration in acceleration of gravity units (g=9.8 meters/sec²) (128 units on y-axis=0 g, 255=+1.5 g, 0=−1.5 g for example).

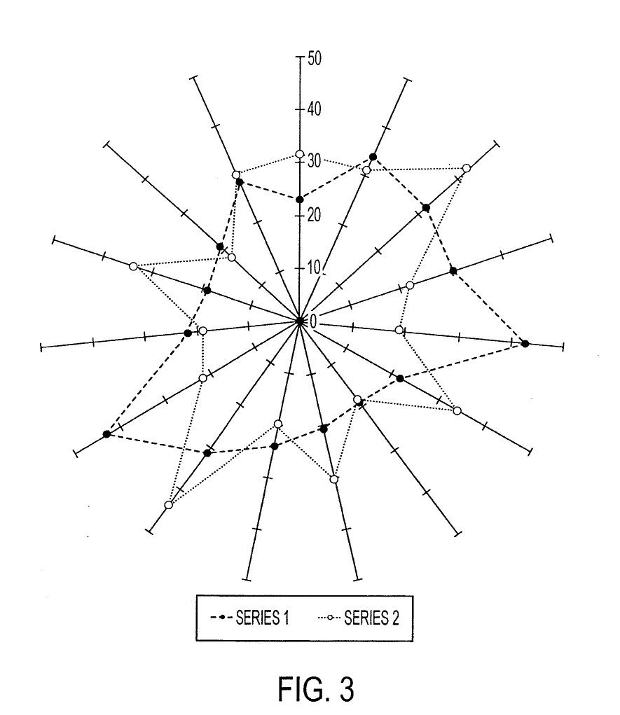

In one embodiment, FIG. 3 is time domain plot showing the distance traversed by an infant wearing the wireless pendant. The wireless pendant sends three dimensional acceleration data (Ax, Ay, Az) measurements or signals five or more or less times a second, for example, to the wireless monitor server. The distance traversed by the infant can be calculated using normalized position vectors. The wireless monitor server preferably performs three-dimensional double integrations five times a second. The Path (x,y,z,t)=Σ∫∫Ax*dt+Σ∫∫Ay*dt+∫∫Az*dt, and each integration result may be summed and accumulated over an observation and monitoring period to provide location data as it relates to the wireless pendant and the infant. In the FIG. 3 example, two of the dimensions are plotted since the wireless pendant and the infant attached to it only moved in a two dimensional plane (x and y and z=0 indicating no height change up or down, such as going up/down stairs, or the like).

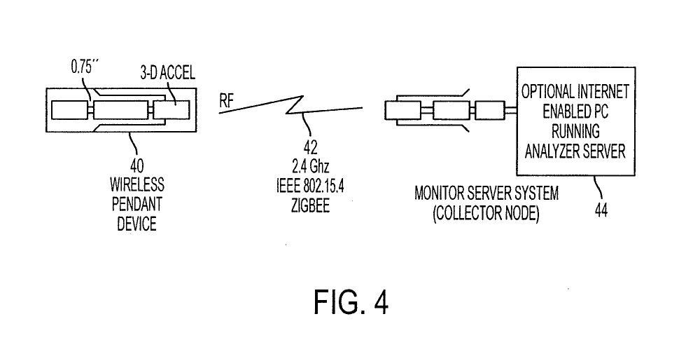

FIG. 4 is a block diagram illustrating an exemplary wireless pendant device and an exemplary wireless monitor server. The wireless pendant device (40) can measure, for example, five acceleration vectors per second for the three dimensions of possible infant movement. The acceleration vectors may be sent via a wireless link (42), such as IEEE 802.15.4 to the wireless monitor server (44). The acceleration vectors may be signal averaged using weighted and/or not-weighted dynamically sized moving average convolution filters (although other methods can be used), and used to determine distances traversed by the infant. Further analysis is performed by the wireless monitor server (44) to determine motion “groups” of events (rollovers, sudden spins, falls, or the like), which are used as input to calculate the differential acceleration time derivatives ([d(Ax)/dt]²+[d(Ay)/dt]²+[d(Az)/dt]²) algorithm for three dimensional shake and tremor detection.

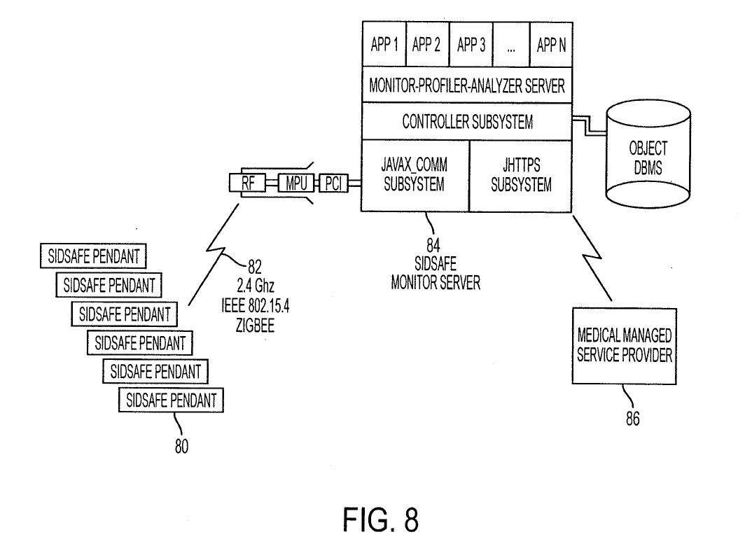

FIG. 8 is an exemplary process flow chart showing the end-to-end processing and communication steps of the wireless pendant (80) to the wireless monitor server (84) to the medical-managed service provider (86), including the data flow between processing steps.

In one embodiment, the wireless pendant device (80), which can be attached to or placed on or within an infant's diaper (or any part of the infant's clothing such as shirt or bloomer, a bracelet, a necklace, an anklet) to be monitored, contains three accelerometers, one for each dimension X, Y and Z used to measure motion. Besides detecting major critical events, such as rollovers and falling, the pendant can generate a profile of an infant's movements and correlate the spatial-temporal dynamics of the infant's movements with the wireless pendant attached to the infant's diaper (or any part of the infant's clothing). This real-time/heuristic information may allow for measuring and detecting motion-related events. Such motion-related events have been correlated with certain medical conditions, for example, specific SIDS development progression.

In one embodiment, various states of motion, such as static, rollover, free-fall, impact, shaking, complex linear and angular motion, can be detected. A unique differential acceleration time derivative algorithm with heuristic functionality may be used to detect the various states of motion. In one embodiment, the output from the pendant corresponding to the acceleration axes can be sampled with a 10-bit Analog Digital Converter (ADC). The 10-bit ADC may be contained in a microcontroller in a wireless pendant device. The micro controller may integrate the sampled data and feeds it to a core processor, preferably in the wireless pendant device.

In one embodiment, the wireless monitor server may (84) generate alarms and alerts based on pre-determined rules and the type of application used through a securely attached Internet-enabled PC. The alarms and alerts may be indicators that can be dispatched to individuals identified as responders (neighbors, friends/family, or emergency service providers such as local community police, social worker, fire or ambulance) and/or medical managed service providers.

In one embodiment, inactivity concerns cam be monitored based on the wireless monitor server's (84) pre-determined template-based software rules. If there is a predetermined period of inactivity detected within a selected time period, notification such as the appropriate alarms and alerts can be sent to the responders and/or medical managed service provider. In one embodiment, the wireless monitor server (84) can activate commands (rule sets) for desired functions as a result of specific infant body movements detected by the wireless pendant device and sent to the wireless monitor server. In one embodiment, the wireless pendant device (80) is preferably waterproof and weighs less than 1 ounce.

In one embodiment, for data reliability, the wireless pendant (80) and wireless monitor server (84) use the wireless IEEE 802.15.4 ZigBee mesh network (82) technology standard. Other wireless communication standards may be suitable. By placing the wireless IEEE 802.15.4 ZigBee receivers and transmitters in groups, the mesh network that results may provide redundant paths to ensure alternate data path routes exist and there may be no single point of failure should a node fail.

Wireless IEEE 802.15.4-compliant ZigBee routers (i.e. ad hoc mesh networks) can be used to greatly extend the range of the network by acting as relays for nodes that are too far apart to communicate directly to the monitor server. In one embodiment, the system uses this wireless technology standard for the communication required between the wireless pendant and the wireless monitor server.

In one embodiment, the wireless data communications implement a 128-bit AES (Advanced Encryption Standard) algorithm for encryption and incorporate the security contained within IEEE 802.15.4. The security services implemented include known methods for key establishment and transport, device management and frame protection. The system leverages the security concept of a “Trust Center.” The “Trust Center” can allow the system's node devices into the network, distribute keys and enable end-to-end security between the wireless pendant and wireless monitor servers.

In one embodiment, the wireless pendant (80) can use a IEEE 802.15.4 compliant 2.4 GHz Industrial, Scientific, and Medical (ISM) band Radio Frequency (RF) transceiver. The transceiver preferably contains a complete 802.15.4 physical layer (PHY) modem designed for the IEEE 802.15.4 wireless standard, which supports peer-to-peer, star and mesh networking. The transceiver preferably is combined with a microcontroller processor unit (MPU) to create the required wireless RF data link and network. In one embodiment, the IEEE 802.15.4 compliant transceiver supports 250 kbps O-QPSK data in 5.0 MHz channels and full spread-spectrum encode and decode. The transceiver can comply with other known standards that provide suitable capabilities.

In one embodiment, control, reading of status, writing of data and reading of data can be done, preferably, through an RF transceiver interface port. The wireless pendant (80) MPU may access the wireless pendant RF transceiver through interface “transactions” in which multiple bursts of byte-long data are transmitted on the interface bus. Each transaction can be three or more or less bursts long depending on the transaction type. Transactions are operations such as read accesses or write accesses to register addresses. The associated data for any single register access may be at least 16 bits in length, although shorter or longer bit lengths can be used.

In one embodiment, receive mode is preferably a state where the wireless pendant (80) RF transceiver is waiting for an incoming data frame. Packet receive mode may allow the wireless pendant RF transceiver to receive an entire packet without intervention from the wireless pendant MPU. The entire packet payload can be stored in memory, such as RX Packet RAM, and a microcontroller may fetch the data after determining the length and validity of the RX packet.

In one embodiment, the wireless pendant (80) RF transceiver waits for a preamble followed by a Start of Frame Delimiter. From there, the Frame Length Indicator may be used to determine length of the frame and calculate the Cycle Redundancy Check (CRC) sequence. After a frame is received, the wireless pendant application may determine the validity of the packet. Due to noise, it is possible for an invalid packet to be reported with the following exemplary conditions: a valid CRC and a valid frame length (0,1, or 2) and/or Invalid CRC/invalid frame length. The wireless pendant application software may determine if the packet CRC is valid and that the packet frame length is valid, for example, a value of 3 or greater or lesser.

In one embodiment, in response to an interrupt request from the wireless pendant(80) RF transceiver, the wireless pendant MPU determines the validity of the frame by reading and checking valid frame length and CRC data. The receive packet RAM register may be accessed when the wireless pendant (80) RF transceiver is read for data transfer.

In one embodiment, the wireless pendant (80) RF transceiver preferably transmits entire packets without intervention from the wireless pendant MPU. The entire packet payload is preferably pre-loaded in another memory, such as TX Packet RAM, the wireless pendant RF transceiver transmits the frame and a transmit complete status may be given to the wireless pendant (80) MPU. In one embodiment, when the packet is successfully transmitted, a transmit interrupt routine that runs on the wireless pendant MPU reports the completion of packet transmission. In response to the interrupt request from the wireless pendant(80) RF transceiver the wireless pendant (80) MPU may read the status to clear the interrupt and check for successful transmission.

In one embodiment, control of the wireless pendant (80) RF transceiver and data transfers are preferably accomplished by means of a Serial Peripheral Interface (SPI). Although the normal SPI protocol is based on 8-bit transfers, the wireless pendant RF transceiver may impose a higher level transaction protocol that is based on multiple 8-bit transfers per transaction. A singular SPI read or write transaction consists of an 8-bit header transfer followed by two 8-bit data transfers. The header may denotes the access type and the register address. The bytes following the header may be read or write data. The SPI may also support recursive ‘data burst’ transactions in which additional data transfers can occur. The recursive mode is intended for Packet RAM access and fast configuration of the wireless pendant (80) RF transceiver.

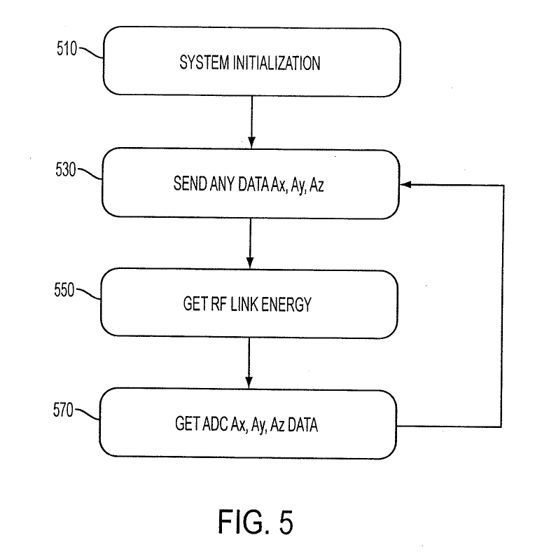

In one embodiment, the software architecture for the wireless pendant (80) device's MPU preferably uses an interrupt-driven architecture. Other architectures can be used. The interrupt routines may include, among other operations, the reading of the ADC (Analog Digital Converter) timers for creating sampling frequency and handling interrupts from the IEEE 802.15.4-compliant RF Transceiver. Non-interrupt routines (510-570) run on the wireless device's MPU may be system initializations and the wireless communications to the wireless monitor server system, which are shown in the block diagram of FIG. 5.

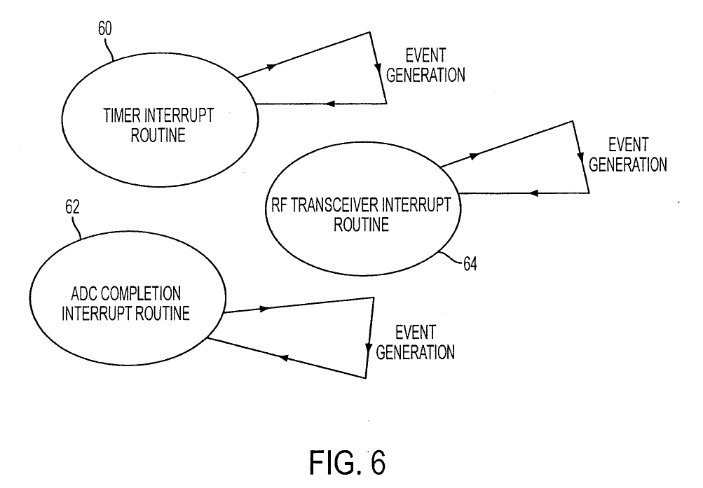

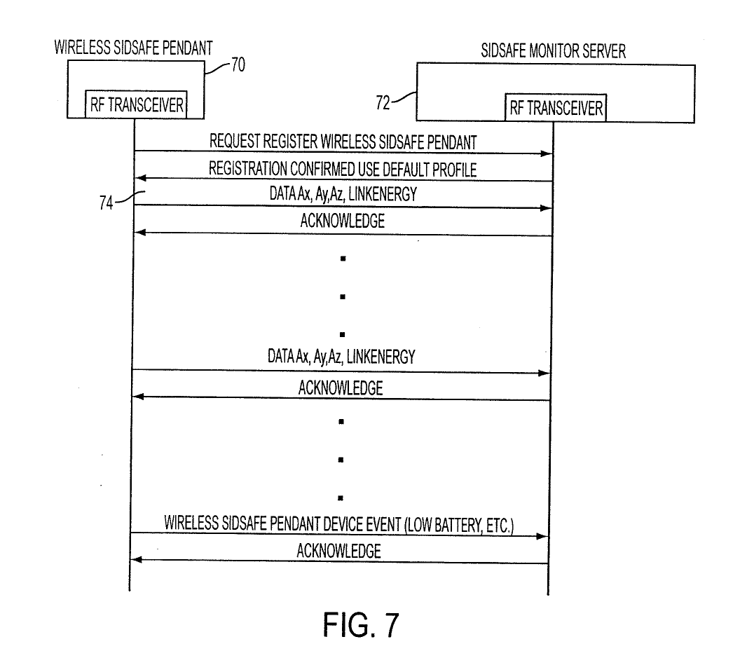

In one embodiment, there may be a number of interrupt handlers that process data asynchronously from the non-interrupt main loop routine described above. As shown in FIG. 6, the first may be a Timer interrupt routine (60), which is used as a time base and generates the sampling rate frequency used by the ADC. The second may be an ADC interrupt routine (62), which runs when the ADC conversion of the three acceleration vectors Ax, Ay, Az is complete. The ADC Interrupt routine (62) may format the ADC readings for read by the non-interrupt main processing loop. The third may be the wireless pendant device's RF transceiver status and data transfers interrupt handler (64). This routine may be used to process the wireless pendant device's RF transceiver events, transmit acceleration (Ax, Ay, Az) data/link energy data via wireless pendant device's RF transceiver to the monitor server system and receive control/acknowledgement data via the wireless pendant device's RF transceiver from the wireless monitor server. FIG. 7 is an exemplary sequence diagram illustrating successful transmission of acceleration data (Ax, Ay, Az) (74) from the wireless device (70) to the wireless monitor server (72).

In one embodiment, the wireless monitor server's software may be a multi-threaded Java-based server that handles one or more wireless pendant device communication channels for data gathering/control and secure internet communications with a medical managed service provider. The Java language was chosen to provide the broadest base of support for wireless monitor server hardware platform.

FIG. 8 illustrates exemplary internal subsystems of the wireless monitor server (84). In one embodiment, the wireless monitor server (84) collects wireless pendant three dimensional acceleration data (Ax, Ay, Az) with the signal strength (Link energy) associated with the wireless communications channel between the wireless pendant (80) and the wireless monitor server (84). The three dimensional acceleration data of the wireless pendant (80), which may be sampled a minimum number of times, preferably five times a second, for each dimension, reflects the motion dynamics experienced by the wearer of the wireless pendant (80) in real-time.

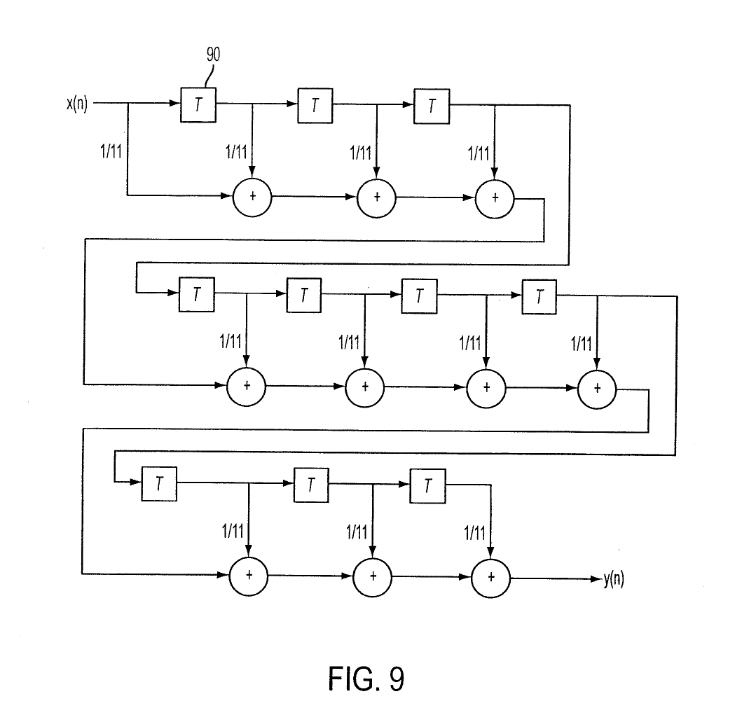

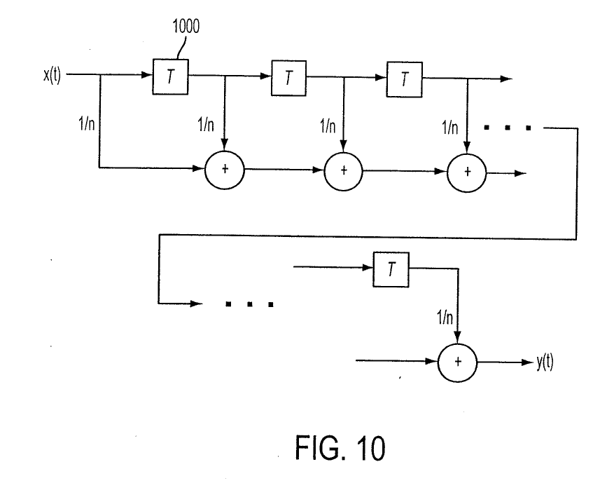

In one embodiment, once the wireless monitor server receives the wireless pendant three dimensional acceleration data, normalization operations are performed on the acceleration data to remove zero gravity (g) offsets and/or any other known conditions that would produce data anomalies or. Next, the wireless monitor server may apply several signal averaging and Finite Impulse Response (FIR), shown in FIGS. 9 and 10 as block T (90, 1000), filtering algorithms to the acceleration data for smoothing and signal noise reduction. In one embodiment, this processed acceleration data now represents a time-series of dynamic events that may now be recorded and analyzed for fall detection, shaking and tremor events.

In one embodiment, the wireless monitor server may have several differential acceleration templates ([d(Ax)/dt]²+[d(Ay)/dt]²+[d(Az)/dt]²) in memory that profile the changes in acceleration data that exist when falls, shaking and/or tremors occur. These templates may be used to correlate the real-time acceleration data from the wireless pendant with known events such as falls, shaking and/or tremors contained in the differential acceleration templates. In one embodiment, when the wireless monitor server detects a infant rollover or fall (or any other significant event), it may immediately generate an alarm and notify persons and services on a preprogrammed call list for a particular infant having the wireless pendant attached via its diaper (or any part of the infant's clothing).

In one embodiment, the wireless monitor server (84) may archive data locally and at a medical managed service provider (86) when necessary. When analyzing specific situations such as SIDS development progression, large amounts of data preferably need to be archived for data mining purposes and, in this case, the additional data storage of a medical managed service provider (86) or elsewhere can be used. In one embodiment, the wireless monitor server can correlate events such as rollovers, falls, shaking and/or tremors with preprogrammed sleeping or feeding schedules.

In one embodiment, the wireless monitor server (84) may be designed with a layered software architecture that supports multi-threading for concurrent processing of wireless pendants, real-time data analysis, event processing, and medical managed service provider communication. The wireless monitor server (84) preferably runs on a Java Virtual Machine (JVM) architecture so as to support a broad range of computing platforms.

In one embodiment, the wireless monitor server software may use a default Finite Impulse Response (FIR) filter that is implemented using an eleventh-order moving average convolution filter whereby the filter coefficients are found via:

B(i)=1/(P+1) for i=0, 1, 2, . . . P

Where P=10 for creating the eleventh-order filter. The impulse response for the resulting filter is:

h(n)=δ(n)/11+δ(n−1)/11+δ(n−2)/11+δ(n−3)/11+δ(n−4)/11 +δ(n−5)/11+δ(n−6)/11+δ(n−7)/11+δ(n−8)/11+δ(n−9)/11 +δ(n−10)/11+δ(n−11)/11

In one embodiment, the wireless monitor server software also uses a dynamic sized (ordered) Finite Impulse Response (FIR) filters based on profiling requirements that may be implemented using n^{th}-order moving average convolution filters whereby the filter coefficients are found via:

B(i)=1/(P+1) for i=0, 1, 2, . . . P

Where P=n−1 for creating the n^{th}-order filter. The impulse response for the resulting filter is:

h(t)=δ(t)/n+δ(t−1)/n+δ(t−2)/n+. . . +δ(t−n)/n

In one embodiment, the moving average convolution filter size may be a function of the application that would run above the wireless monitor server software layer. The application could be an SIDS development infant mobility profiler, or a monitor for epileptic seizures in infants to help correlate their anti-epileptic drug schedules, to name a few applications for these devices and methods. These applications may have their own specialized requirements based on mobility dynamics to be monitored and profiled.

In one embodiment, Micro Electro Machine Systems (MEMS) can be incorporated into the design of any of the devices to allow sensor data to be collected when the sensors are in close proximity to one another. Typical software languages such as C++, assembly language, C# and/or Java can be used to implement the system's functionality. Alternatively, the system functionality can be implemented in hardware or firmware or any combination thereof including software.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. An apparatus for wireless autonomous mobility detection, monitoring and analysis, comprising:
a wireless pendant device; and
a wireless monitor server,
wherein the wireless pendant device is configured to measure acceleration motion of a subject, to generate acceleration data from the acceleration motion and to communicate the acceleration data with the wireless monitor server and
wherein the wireless monitor server is configured to analyze the acceleration data communicated by the wireless pendant device and to provide an output related to the analysis.

2. A method for wireless autonomous mobility detection, monitoring and analysis comprising:
measuring acceleration motion of a subject using a wireless pendant device;
generating acceleration data from the motion;
sending the acceleration data from the wireless pendant to a wireless monitor server;
analyzing the data to detect and monitor the motion of the subject; and
providing an output related to the detection and monitoring of the motion of the subject.

3. The method of claim 2, comprising:
signal averaging and temporally smoothing the collected acceleration data using dynamically sized moving average convolution filters to produce processed data and storing the processed data.

4. The method of claim 2, comprising:
using dynamically sized moving average convolution filters to produced processed data and storing the processed data;
using the processed data to create differential acceleration time derivatives data to determine critical events, store any critical events, and generate alarms based on exceeding predetermined thresholds for critical events;
profiling and correlating the processed data with stored template profiles and measuring correlation;
using results from the profiled and correlated processed data to determine a path traversed by a subject with the wireless pendant; and
performing mobility tests and recording, benchmarking, and archiving the results of the mobility tests.

5. The method of claim 4, comprising:
correlating the wireless device mobility data generated by the subject with sleeping or feeding schedules of the subject;
correlating the subject's wireless pendant mobility data with Sudden Infant Death Syndrome (SIDS)-like development progression;
archiving the stored wireless pendant result data with a medical managed service provider;
profiling and correlating the spatial-temporal dynamics of the subject with a wireless device attached to the subject for determining gross movements generated by the subject for purposes of correlating the collected data with any other spatial-temporal data.

6. The method of claim 2, wherein said wireless monitor server collects wireless pendant acceleration motion data for archival storage and heuristic analysis.

7. The method of claim 2, wherein the analysis comprises signal averaging and dynamically sized moving average convolution filters as a function of a profile template on collected wireless device acceleration data.

8. The method of claim 2, wherein said wireless monitor server profiles and correlates differential acceleration time derivatives on data collected by the wireless pendant device.

9. The method of claim 2, wherein the wireless monitor server profiles and correlates the data to determine critical events such as rollover, falling, shaking and/or tremors and storing determined critical events for the subject with the wireless device.

10. The method of claim 2, wherein the wireless monitor server is configured to generate alarms to a medical managed service provider.

11. The method of claim 2, wherein the wireless monitor server profiles and correlates spatial-temporal dynamics of the subject with the wireless pendant device attached to determine mobility for the purposes of SIDS development progression.

12. The method of claim 2, wherein the wireless monitor server profiles and correlates spatial-temporal dynamics of the subject with the wireless pendant device attached to determine mobility for the purposes of creating or modulating sleeping or feeding schedules.

13. The method of claim 2, wherein the wireless monitor server profiles and correlates spatial-temporal dynamics of the subject with the wireless pendant device attached to the subject for recording, benchmarking, and heuristic archiving of subject's mobility characteristics.

14. The method of claim 2, wherein the wireless monitor server determines the path traversed by the subject with the wireless pendant device attached to the subject for mobility analysis of the subject.

15. The method of claim 2, wherein the wireless monitor server profiles and correlates the spatial-temporal dynamics of the subject with the wireless pendant device for determining gross movements generated by the subject for purposes for purposes of correlating this data with any other spatial-temporal data.

16. The method of claim 2, wherein the wireless pendant device is attached to a subject's clothing.

17. The method of claim 2, wherein the wireless pendant device is attached to the subject's body.

18. The method of claim 2, wherein the wireless pendant device is configured to be mounted to a structure configured to contain the subject and wherein the wireless pendant device monitors spatial-temporal mobility dynamics of the subject in the structure.

19. A computer-readable medium having computer-readable instructions stored thereon for execution by a processor to perform a method for wireless autonomous mobility detection, monitoring and analysis comprising:
measuring acceleration motion of a subject using a wireless pendant device;
generating acceleration data from the motion;
sending the acceleration data from the wireless pendant to a wireless monitor server;
analyzing the data to detect and monitor the motion of the subject; and
providing an output related to the detection and monitoring of the motion of the subject.

20. The apparatus of claim 1, wherein the wireless pendant device and the wireless monitor server communicate via a mesh-type wireless network.

21. The method of claim 2, wherein the acceleration data from the wireless pendant to the wireless monitor server is sent via a mesh-type wireless network.

22. The computer-readable medium of claim 19, wherein the acceleration data from the wireless pendant to the wireless monitor server is sent via a mesh-type wireless network.
